(19) United States
(12) Patent Application Publication
(10) Pub. No.: US 2011/0262696 A1
(43) Pub. Date: Oct. 27, 2011

(54) MEDICAL DEVICE INCLUDING A BACTERIAL CELLULOSE SHEET, PERFORATED OR MICROPERFORATED AS A MESH

(75) Inventors: Yves Bayon, Lyon (FR); Sébastien Ladet, Lyon (FR); Olivier Lefranc, Chatillon Sur Chalaronne (FR); Philippe Gravagna, Irigny (FR)

(73) Assignee: SOFRADIM PRODUCTION, TREVOUX (FR)

(21) Appl. No.: 13/125,604

(22) PCT Filed: Nov. 6, 2009
(86) PCT No.: PCT/IB2009/007662

§ 371 Date: Jul. 11, 2011

Related U.S. Application Data
(60) Provisional application No. 61/112,324, filed on Nov. 7, 2008.

(51) Int. Cl. B32B 3/10; B29C 35/08

(52) U.S. Cl. 428/131; 264/400

(57) ABSTRACT

The present invention relates to a medical device comprising a bacterial cellulose sheet having perforations. The invention further relates to a method of making such a medical device.

The present disclosure relates to medical devices including a perforated bacterial cellulose sheet. The disclosure also relates to the use of the medical device for indications where soft tissues need to be repaired, reinforced or replaced such as, for example, the abdominal wall or pelvic floor.

An aspect of the present invention is a medical device comprising a bacterial cellulose sheet having perforations. The bacterial cellulose sheet may have a thickness of from about 0.1 mm to about 5 mm. In embodiments, the perforations comprise holes of a size from about 10 μm and 100 μm, separated from each other by a distance of from about 0.1 mm to about 3 mm. In embodiments, the perforations comprise holes of a size of from about 1 mm to about 3 mm, separated from each other by a distance of from about 0.3 mm to about 5 mm. In embodiments, the perforations comprise holes of a size of from about 10 μm to about 100 μm, separated from each other by a distance of from about 100 μm to about 500 μm. In embodiments, the holes are arranged in an ordered series. In embodiments, the bacterial cellulose sheet comprises a first area having perforations and a second area containing no perforations. In embodiments, the bacterial cellulose sheet comprises a first area having perforations of a first size and a second area having perforations of a second size different from the first size. In embodiments, the bacterial cellulose sheet comprises a first area with perforations arranged in a first pattern and a second area with perforations arranged in a second pattern different from the first pattern. The perforations may be circular.

Another aspect of the invention is a method of making a medical device comprising:

providing a bacterial cellulose sheet; and
perforating the bacterial cellulose sheet.

The bacterial cellulose sheet provided may be derived from Acetobacter xylinum. In embodiments, the bacterial cellulose sheet provided comprises oxidized cellulose. In embodiments, perforating the bacterial cellulose sheet forms holes of a size of from about 10 μm and 100 μm, separated from each other by a distance of from about 0.1 mm to about 3 mm. In embodiments, perforating the bacterial cellulose sheet forms holes of a size of from about 1 mm to about 3 mm, separated from each other by a distance of from about 0.3 mm to about 5 mm. In embodiments, perforating the bacterial cellulose sheet forms holes of a defined and constant size of from about 10 μm to about 100 μm, separated from each other by a constant distance of from about 100 μm to about 500 μm. In embodiments, perforating the bacterial cellulose sheet forms an ordered series of holes. In embodiments, an area of the bacterial cellulose sheet remains unperforated. Perforating may be performed by a method selected from the group consisting of punching and laser drilling.

Another aspect of the present invention is a method of repairing a wound comprising contacting a wound with a medical device as described above.

In the present disclosure, the microbial cellulose as wet pellicles or films may be produced from bacteria that synthesize cellulose. Cellulose is synthesized by bacteria belonging to the genera Acetobacter, Rhizobium, Agrobacterium, and Sarcina. Cellulose may be produced by certain bacteria from glucose in the presence of oxygen, (such as, for example, Acetobacter xylinum, referenced hereinafter as the “bacteria”), in static conditions or in a bioreactor (see, e.g. U.S. Pat. Nos. 4,912,049 and 5,955,326, the entire disclosures of which are incorporated herein by this reference). Cellulose suitable for use in the present implants may be obtained by the fermentation of the bacteria. In embodiments, a derivative of the cellulose is employed, such as oxidized cellulose resulting from the oxidation of the cellulose by periodic acid or nitrogen dioxide.

Microbial cellulose possesses inherent characteristics which allow effective promotion of wound healing (see, e.g. U.S. Pat. No. 7,390,492, the entire disclosure of which is incorporated herein by this reference). In this regard, microbial cellulose displays properties that distinguish it from plant cellulose and other natural polymeric materials, such as a unique multi-layer three dimensional laminar structures. Microbial cellulose shows excellent wet strength, does not easily breakdown under compression and demonstrates high moisture handling ability. When implanted in vivo, bacterial cellulose pellicles or films are rather slowly integrated in tissues and cell colonized.

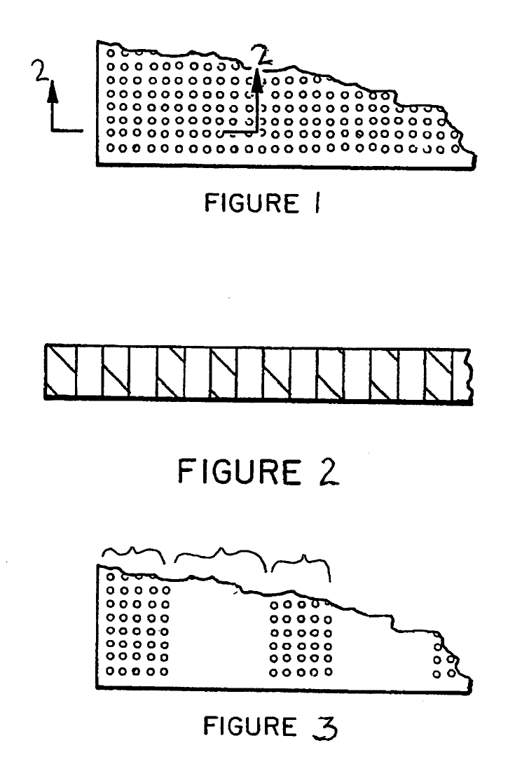

Methods for producing cellulose pellicles or films in accordance with the present disclosure involve culturing cellulose-producing bacteria in culture vessels or bioreactors to produce microbial pellicles or films which are microperforated or perforated. (See FIGS. 1 and 2) Perforation of the film increases the rate of tissue integration of the present cellulose devices compared to non-perforated films. The present devices are therefore useful wherever a healing support is needed for the reinforcement, repair or replacement of soft tissues.

In embodiments, the devices resulting from the growth of the bacterial cellulose sheets according to the present disclosure, can have a final thickness of from about 0.1 mm to about 5 mm, in embodiments, of from about 0.3 mm to about 1.5 mm. In embodiments, the perforations can be an ordered series of holes of a defined and constant size of from about 10 μm and 100 μm, separated from each other by a constant distance of from about 0.1 mm to about 3 mm, in embodiments, from about 0.5 mm to about 1 mm. Such devices are hereafter referenced as microperforated cellulose sheets.

In embodiments, these and further devices may be attained by the bacterial cellulose sheets according to the present disclosure, having a final thickness of from about 0.1 mm to about 5 mm, in embodiments, of from about 0.5 mm to about 3 mm, and having an ordered series of holes of a defined and constant size of from about 1 mm to about 3 mm, separated from each other by a constant distance of from about 0.3 mm to about 5 mm, in embodiments, of from about 0.5 mm to about 2 mm. Such devices are hereafter referenced as perforated cellulose sheets.

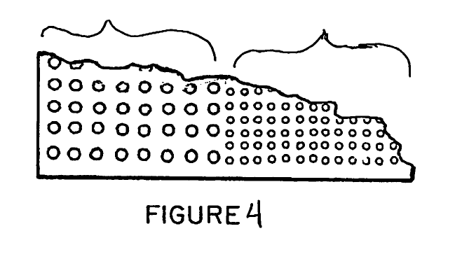

In embodiments, the devices described herein include two or more areas having different sets of perforations. (See FIG. 4) For example, a first area may have a first set of perforations having a first set of characteristics and a second area may have a second set of perforations having a second set of characteristics. Thus, a sheet having a first area perforated in one area as described in the previous paragraph may be perforated in another area to provide holes of a defined and constant size of from about 10 μm to about 100 μm, separated from each other by a constant distance of from about 100 μm to about 500 μm, in embodiments, of from about 100 μm to about 200 μm.

In embodiments, the holes in the devices may not be simply ordered, but may be arranged according to more complex sequences. For example, the distance between holes may vary across the surface of the device. As another example, the sheet may include rows of closely spaced holes separated by some distance. In embodiments, a series of five rows of 100 μm diameter holes may be separated by each other at a distance of from about 200 μm to about 400 μm and this series of holes may be separated from another series of similarly sized and spaced rows by distance of from about 1 mm to about 5 mm. (See FIG. 3)

According to the present disclosure, the holes of the perforated and microperforated cellulose sheets may have any shape or geometry. For example, the holes may be a circle, a square, a rectangle, an oval, or an ellipse. It should be understood that the use of other shapes or combinations of shapes are also contemplated.

Continuous perforated or microperforated bacterial cellulose sheets may be prepared by any conventional methods known in the art.

The perforated and microperforated cellulose sheets according to the present disclosure may be obtained using mechanical perforation devices such as suitably arranged punching machines. Alternatively, thermal or ultraviolet lasers operating in a frequency band such as to produce holes of the required size and distance apart in the cellulose sheet may be used.

The perforated and microperforated cellulose sheets according to the present disclosure may also be obtained by other suitable processes, such as vacuum, needle or water jet perforation, hot pins, embossing, and combinations thereof.

In embodiments, perforation of the cellulose sheets may be performed on wet or dry materials.

In embodiments, perforation of the cellulose sheets may be performed at the end of the fermentation process when the cellulose pellicles or films are harvested. In embodiments, perforation may be performed when the medical device is at the final processing stage. At this stage, the cellulose sheets may be perforated or microperforated, then cut to shape and sizes appropriate for the envisaged application. The cellulose sheets may be packaged in single or dual pouches and sterilized using conventional techniques, such as, but not limited to, irradiation with beta (electronic irradiation) or gamma (irradiation using radioactive cobalt) rays at about 25 KGy to about 35 KGy, and/or sterilized by ethylene oxide. In embodiments where hydrolytically unstable materials are used in forming the implant, the cellulose sheets are packaged under sufficiently dry conditions to ensure that no degradation of the composite takes place during storage.

The present medical devices including bacterial cellulose sheets which are microperforated or perforated, may advantageously maintain one or more of the unique properties of bacterial cellulose sheets. For example, the present sheets may exhibit high biocompatibility, extreme hydrophilicity, a multi-layered three dimensional laminar structures providing excellent moisture handling properties, excellent wet strength, high resistance to breakdown under compression, conformability and the absence of generation of harmful particles of the cellulose mesh after rubbing against surrounding tissues or erosion at sharp edges of tissues (e.g., sharp edges of bone and cartilage tissues).

The perforated bacterial cellulose sheets of the present disclosure may be used for the repair, reinforcing and/or replacement of soft tissues, such as for example, the abdominal wall and pelvic floor.

It will be understood that various modifications may be made to the embodiments disclosed herein. Thus, those skilled in the art will envision other modifications within the scope and spirit of the disclosure.

1-19. (canceled)

20. A medical device comprising a bacterial cellulose sheet having perforations.

21. The medical device of claim 20, wherein the bacterial cellulose sheet has a thickness of from about 0.1 mm to about 5 mm.

22. The medical device of claim 20, wherein the perforations comprise holes of a size from about 10 μm and 100 μm, separated from each other by a distance of from about 0.1 mm to about 3 mm.

23. The medical device of claim 20, wherein the perforations comprise holes of a size of from about 1 mm to about 3 mm, separated from each other by a distance of from about 0.3 mm to about 5 mm.

24. The medical device of claim 20, wherein the perforations comprise holes of a size of from about 10 μm to about 100 μm, separated from each other by a distance of from about 100 μm to about 500 μm.

25. A medical device of claim 20, wherein the holes are arranged in an ordered series.

26. A medical device of claim 20, wherein the bacterial cellulose sheet comprises a first area having perforations and a second area containing no perforations.

27. A medical device of claim 20, wherein the bacterial cellulose sheet comprises a first area having perforations of a first size and a second area having perforations of a second size different from the first size.

28. A medical device of claim 20, wherein the bacterial cellulose sheet comprises a first area with perforations arranged in a first pattern and a second area with perforations arranged in a second pattern different from the first pattern.

29. A medical device of claim 20, wherein the perforations are circular.

30. A method of making a medical device comprising:
providing a bacterial cellulose sheet; and
perforating the bacterial cellulose sheet.

31. The method of claim 30, wherein the bacterial cellulose sheet provided is derived from Acetobacter xylinum.

32. The method of claim 30, wherein the bacterial cellulose sheet provided comprises oxidized cellulose.

33. A method of claim 30, wherein perforating the bacterial cellulose sheet forms holes of a size of from about 10 μm and 100 μm, separated from each other by a distance of from about 0.1 mm to about 3 mm.

34. A method of claim 30, wherein perforating the bacterial cellulose sheet forms holes of a size of from about 1 mm to about 3 mm, separated from each other by a distance of from about 0.3 mm to about 5 mm,

35. A method of claim 30, wherein perforating the bacterial cellulose sheet forms holes of a defined and constant size of from about 10 μm to about 100 μm, separated from each other by a constant distance of from about 100 μm to about 500 μm.

36. A method of claim 30, wherein perforating the bacterial cellulose sheet forms an ordered series of holes.

37. A method of claim 30, wherein an area of the bacterial cellulose sheet remains imperforated.

38. A method of claim 30, wherein perforating is performed by a method selected from the group consisting of punching and laser drilling.
